(19) United States
(12) Patent Application Publication
(10) Pub. No.: US 2012/0145484 A1
(43) Pub. Date: Jun. 14, 2012

(54) LUBRICATION STATION

(75) Inventor: Michael FASSBINDER, Volkach (DE)

(73) Assignee: SCHAEFFER TECHNOLOGIES GMBH & CO. KG, Herzogenaurach (DE)

(21) Appl. No.: 13/015,166

(22) Filed: Jan. 27, 2011

(30) Foreign Application Priority Data
Dec. 13, 2010 (DE) 20 2010 016 511.3

(51) Int. Cl. F16N 5/00; F16N 25/00; F16N 13/00

(52) U.S. Cl. 184/26

(57) ABSTRACT

A lubrication station for lubricating a bearing with a lubricant. The lubrication station has a pump for pumping the lubricant, a receptacle for receiving the lubricant as a lubricant stock for the pump, a receiving device for receiving the pump and the receptacle in a transportable and operable state, and a mechanical interface for lifting or lowering and/or carrying the lubrication station. The lubrication station is a mobile standing device.

### FIELD OF THE INVENTION

The invention concerns a lubrication station for lubricating a bearing with a lubricant, said lubrication station comprising a pump for pumping the lubricant, a receptacle for receiving the lubricant as a lubricant stock for the pump, a receiving device for receiving the pump and the receptacle in a transportable and operable state, and a mechanical interface for lifting or lowering and/or carrying the lubrication station.

Lubrication stations of the pre-cited type are used as a rule for lubricating rolling bearings, particularly large rolling bearings with a diameter larger than 500 mm. Such large rolling bearings are integrated, for instance, in wind power plants. These are generally greased through portable and manually operated lubricating devices or through intensive-maintenance permanent bushings installed permanently in the wind power plant.

The document DE 200 21 026 U1, for example, describes a central greasing equipment comprising a grease receptacle for lubricating a bearing integrated in a wind power plant, said grease receptacle being easily removable from the pump and capable of being refilled at an appropriate location. The grease receptacle can also be configured as an interchangeable receptacle.

The document U.S. Pat. No. 7,249,695 B2 discloses an energy-autarkic, portable grease gun with a grease receptacle, a grease pump and an actuating lever. The grease gun possesses a device for eliminating a clogging in a connecting nozzle, which device can be activated by operating the actuating lever. After activation, the device is configured for raising the temperature and the pressure in the interior of the grease gun for thus eliminating the clogging.

### DESCRIPTION

It is the object of the invention to provide a mobile and easy-to-operate lubrication station having an adequate lubricant stock. This object is achieved with the features of claims 1, 13 and 15. Preferred or advantageous examples of embodiment of the invention result from the dependent claims, the following description and/or the appended figures.

The scope of the invention includes a lubrication station for lubricating a bearing with a lubricant, particularly lubricating grease. The lubrication station is preferably suitable and/or configured for lubricating large rolling bearings having a pitch circle diameter of more than 500 mm, particularly more than 1000 mm, and especially more than 2000 mm. The lubrication station is configured, in particular, for lubricating large rolling bearings that are integrated in wind power plants. Rolling bearings integrated in wind power plants are configured, for instance, as rotor bearings, tower bearings or rotor blade bearings.

The lubrication station comprises a pump, particularly a barrel pump, for pumping the lubricant and a receptacle for receiving the lubricant as a lubricant stock for the pump. The receptacle is preferably configured as a bucket, a tub or as another suitably configured vessel. If required, the receptacle can be refilled or be configured as an interchangeable receptacle for replacement.

The lubrication station comprises a receiving device for receiving the pump and the receptacle in a transportable and operable state. The receiving device is preferably configured as a standing framework. In particular, the standing framework is configured for receiving the pump and the receptacle or for coupling to these and, further, for being placed on a base during a lubricating operation, or for being lifted or lowered during transportation. It is conceivable within the scope of the invention to make the receiving device out of metal or wood, or of a stable and high-strength plastics material.

The lubrication station comprises a mechanical interface for lifting or lowering and/or for carrying the lubrication station. It is particularly preferred to configure the mechanical interface for lifting and/or pulling the lubrication station upwards within a tower of a wind power plant, particularly in direction of a wind power plant car.

Preferably, the mechanical interface is configured as an opening or an eye for engagement of a hook of an external or externally driven lifting device. Alternatively, the mechanical interface can be configured as the hook that engages, for instance, an opening or an eye of the lifting device. It is by all means conceivable within the scope of the invention for the mechanical interface to be constituted by a chain, a rope or another suitable device which, like the aforesaid, is configured for fixing the lubrication station to the lifting device and for enabling a lifting, lowering and transporting of the lubrication station.

According to the invention, the lubrication station is configured as a mobile standing device which, specifically in its operative state, can be placed, or is placed, on the ground. Preferably, the receiving device can be put down reliably and in a functional state at its place of use and set to work in the same body orientation as it had during a lifting operation through the lifting device. Preferably, the lubrication station can be put down on a base and be moved, equipped and/or set to work in the same body orientation as it had during a lifting operation. For example, the lubrication station is ready for use immediately after being lifted up to the wind power plant car and after an optional, supplementary shifting to a delivery point of the lubricant. Preferably, the lubrication station is equipped with the receptacle filled with the lubricant stock and the pump already before or during the lifting operation. In particular, with the exception of a possibly required connection of an electric cable of the pump and an actuation of a hand-held dosing unit that can be connected to the pump, no further preparatory and/or installation work steps are needed for putting the lubrication station into operation at the delivery point.

It is advantageous that the lubrication station as a mobile standing device is configured for use during the equipping of the lubrication station with the receptacle, during transportation of the lubrication station to the wind power plant and during the lifting operation in direction of the wind power plant car. As a mobile standing device, the lubrication station is further configured for use during its movement to the delivery point in the wind power plant car and during lubrication of the rolling bearing. Thus, the lubrication station according to the invention advantageously has at least a triple function as a transporting, lifting and working device.

Due to the fact that the lubrication station can be lifted into the wind power plant car by the external and externally driven lifting device, a user is spared having to lift and carry a generally heavy-weight grease gun. Moreover, because the receptacle has a larger filling volume compared to prior art receptacles, a larger stock of lubricant can be brought to the point of use. This enables an economy of time for a re-delivery of additional lubricant stock and for a repeated assembly of conventional lubrication devices and also in the maintenance of the rolling bearings.

In a preferred form of embodiment of the invention, the receiving device comprises at least one platform and at least one profiled structure, the platform being fixed on the at least one profiled structure and configured for receiving the pump and/or the receptacle. Preferably, the profiled structure is configured as a vertically directed strut or bar. In particular, the platforms are circular, rectangular or polygonal in shape. Preferably, the platform is arranged or fixed at right angles or substantially at right angles to the profiled structure. For instance, the lubrication station comprises a rack structure or a rack-like structure, the platforms forming the rack boards and the profiled structures forming the rack struts.

It is within the scope of the invention to make the receiving device with at least one continuous frame profile that surrounds the at least one platform and through which the platform is connected to the at least one profiled structure. Preferably, the frame profile is connected to the profiled structure by fusion of material, particularly by welding. Optionally, the frame profile and the profiled structure may also be injection molded together during a manufacturing step.

In a particularly preferred embodiment of the invention, the receiving device comprises two platforms and two or more profiled structures. Preferably, the first and the second platform are arranged spaced from each other, particularly above each other and parallel to each other. In particular, the first platform forms a lower platform and the second platform forms an upper platform.

For example, the receptacle for receiving the lubricant as a lubricant stock for the pump is arranged on the lower platform and the pump is arranged on the upper platform. In particular, each of the lower and the upper platform are surrounded by a respective one of the frame profiles while being arranged between the two or more profiled structures.

In one possible embodiment of the invention, the receiving device has a height of at least 500 mm, preferably at least 900 mm and, in particular, at least 1300 mm. The receiving device particularly comprises a suitable height for receiving the receptacle and the pump and an adequate height for being put into operation by a user.

In a preferred constructional embodiment of the invention, the lubrication station comprises a center of gravity. Preferably, the center of gravity is arranged in the at least one platform or in a plane extending parallel to the platform. In particular, the mechanical interface is arranged and/or fixed on the receiving device and situated on an imaginary straight line which—even in the standing position of the lubrication station—extends perpendicularly to a horizontal base through the center of gravity. It is particularly preferable for the mechanical interface to be arranged and/or fixed on the receiving device and be situated on an imaginary straight line which—even in the standing position of the lubrication station—intersects the plane perpendicularly in the center of gravity.

The receiving device preferably comprises fractional profiled sections that are arranged at an angle to the profiled structures and extend towards one another to converge in a crossing or connecting point and/or are connected to one another in the crossing of connecting point. In particular, the crossing or connecting point is arranged on the imaginary straight line and above the at least one platform. In particular, the mechanical interface is arranged in the crossing or connecting point or is connected to this in a prolongation along the straight line.

In a preferred form of embodiment of the invention, the mechanical interface is configured and/or arranged to lift, to lower and/or carry the lubrication station in a ready-for-operation orientation. During the lifting or lowering operation, the lubrication station is preferably oriented or positioned so as to be able to be set down, shifted and equipped and/or be taken into operation reliably in this orientation or position on a base.

In particular, the mechanical interface is configured so as to be coupled to the external and externally driven lifting device that serves for a vertical displacement of the lubrication station. Preferably, the lifting device is configured as a crane or a pulley block and arranged particularly within the wind power plant tower. In particular, the lifting device is suitable and/or configured to raise or transport the lubrication station along the wind power plant tower to the wind power plant car. It is by all means possible within the scope of the invention to likewise configure the lifting device for shifting the lubrication station in horizontal direction, particularly from the wind power plant tower in direction of the wind power plant car and set it down on the base of the wing power plant car.

In particular, the lubrication station comprises a plurality of castors for shifting and/or moving the lubrication station on the base. Preferably, the user can shift, roll or push the lubrication station to the point of delivery. Thus, the user is spared a lifting and carrying of the lubrication station to the point of delivery.

In one possible embodiment of the invention, the receptacle is configured to receive more than 3 kg, preferably more than 6 kg and, in particular, more than 10 kg of the lubricant as a lubricant stock. Advantageously, in contrast to conventional lubrication devices, in most cases, the user has at his disposal sufficient lubricant to complete a lubricating operation of the rolling bearing or bearings without interruption. Thus, through the large filling volume of the receptacle, the user is spared having to go elsewhere, and saves particularly the time he would need to refill the lubricant stock or to replace the receptacle with an interchangeable receptacle.

Preferably, the pump is electrically operated and preferably configured as a barrel pump. Particularly preferably, the pump is configured for energy-autarkic operation. The pump can be operated, for instance, through a battery or an accumulator. Alternatively, or optionally as a supplementary feature, the pump can comprise the electric cable to the current supply of the pump.

In a further possible embodiment of the invention, the lubrication station comprises a counter and/or indicator unit that is configured to detect and/or indicate the quantity of lubricant delivered. Preferably, the counter and indicator unit is configured as a sensor for detecting the quantity of lubricant that is pumped through the pump. In particular, the indicator unit is configured as a display for reproducing or indicating the delivered quantity. Preferably, the lubrication station comprises an evaluation unit and a control unit, wherein the evaluation unit evaluates the delivered quantity detected by the counter unit and the control unit controls the reproduction or indication of the delivered quantity. Alternatively, or optionally as a supplementary feature, the receptacle is transparent and comprises a measure marking on a receptacle wall with the help of which the user can read the remaining and/or already delivered quantity of the lubricant stock in the receptacle.

In one possible embodiment of the invention, the lubrication station comprises a hand-held dosing unit for a manual dosing of the lubricant, said hand-held dosing unit comprising an outlet for letting out lubricant, said outlet being configured to be connected to an external and/or separate feeding device, particularly to the point of delivery. Preferably, the hand-held dosing unit is connected to the pump, particularly through a hose or a tube. Preferably, the hand-held dosing unit is arranged above the upper platform, in particular at a comfortable gripping height for the user, on the lubrication station. For instance, the hand-held dosing unit is preferably attached to the at least one profiled structure or to the pump so as to be removable or detachable.

A further subject matter of the invention concerns a method of lubricating the bearing of the wind power plant with the lubrication station according to one of claims 1 to 11 and/or according to the forgoing description. In this method, the lubrication station is preferably lifted by the lifting device at the mechanical interface to the place of use in the wind power plant.

The use of the lubrication station according to claims 1 to 11, according to the forgoing description and/or preferably according to the method of claim 13 or 14 for lubricating the bearing in the wind power plant constitutes a further subject matter of the invention.

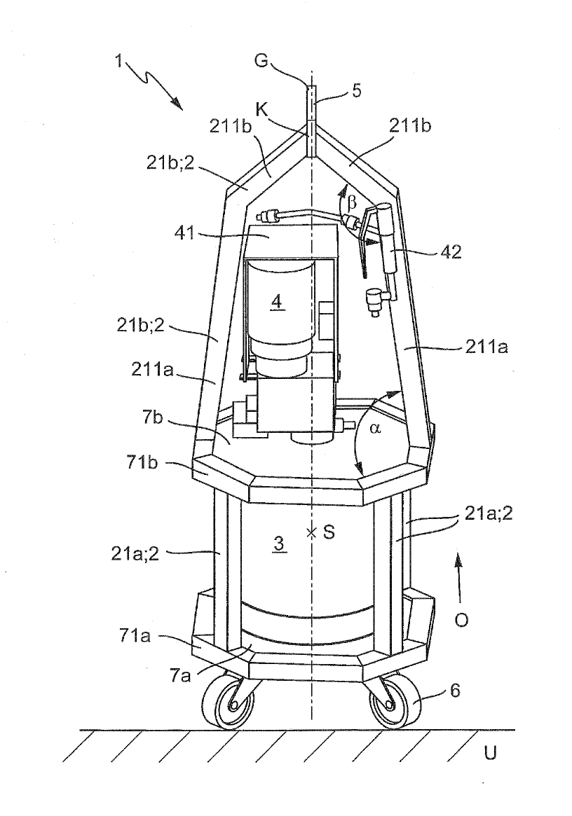

Further features, advantages and effects of the invention result from the following description of a preferred example of embodiment of the invention. Appended FIG. 1 shows a perspective view of a lubrication station.

FIG. 1 shows a perspective view of a lubrication station 1 as an example of embodiment of the invention. The lubrication station 1 is configured for lubricating a large rolling bearing of a wind power plant with a lubricant. The large rolling bearing possesses a diameter of at least 500 mm, preferably at least 1000 mm, in particular at least 2000 mm. The large rolling bearing is particularly configured as a rotor bearing, a tower bearing or a rotor blade bearing of the wind power plant.

The lubrication station 1 comprises a receiving device 2, a refillable or interchangeable receptacle 3, a pump 4, a mechanical interface 5 and, for example, four castors 6. The pump 4 is configured as a pump that functions electrically autarkic. For this purpose, the pump 4 comprises a battery or an accumulator that supplies it with electric current. The pump 4 comprises a counter and/or indicator unit 41 which comprises an evaluation and control device. The pump 4 is connected through a hose to a hand-held dosing device 42 which is fixed, for example, detachably on the receiving device 2. The hand-held dosing device 42 comprises an outlet for delivering the lubricant and said outlet can be connected to an external and/or separate feeding device (not shown) to a point of delivery of the lubricant. The mechanical interface 5 is configured as a reception, particularly in the form of an eye of an external and externally driven lifting device.

The lubrication station 1 is configured as a standing device and, as such, it is configured as a transport, lifting and working device. Prior to transportation to the wind power plant, the lubrication station 1, as a standing device, can be equipped with the receptacle 3 filled with the lubricant stock and be prepared for transportation to the wind power plant. As a standing device, the lubrication station 1 is likewise configured to be lifted by the external lifting device in an operable or ready-to-operate state through a wind power plant tower to a place of use in a wind power plant car. In addition, as a standing device, the lubrication station 1 can be pushed through the castors 6 without a high force application to the point of delivery and be put into operation. As a standing device, the lubrication station 1 is further configured to be set down on the base at the point of delivery and to be used by the user during the lubrication operation in a standing position on the base. After termination of the lubrication operation, the lubrication station 1 can again be lowered through the wind power plant tower as a standing device.

The receiving device 2 comprises a first and a second platform 7a; 7b that possess an octagonal outer contour and a total of six profiled structures 21 which are configured as elongate, stretched metal profiles. The receiving device 2 and the two platforms 7a; 7b are arranged together after the manner of a rack, the profiled structures 21 forming rack struts and the platforms 7a; 7b forming rack boards. Thus, the receiving device 2 resembles a rack structure that has a total height of at least 50 cm, preferably at least 90 cm and particularly 135 cm.

The receiving device 2 comprises two continuous frame profiles 71a; 71b which surround or frame the platforms 7a; 7b. The first frame profile 71a is configured as an upper frame profile and the second frame profile 71b is configured as a lower frame profile. The direction indication “bottom” in the figure identifies the direction towards a base U on which the lubrication station 1 is arranged. The direction indication “top” (see arrow o) extends oppositely to the direction indication “bottom”.

The two frame profiles 71a; 71b are configured and/or arranged for connecting the platforms 7a; 7b to the profiled structures 21, and/or for positioning the platforms 7a; 7b on or between the profiled structures 21. The frame profiles 7a; 7b are connected to the profiled structures 21 by fusion of material, in particular, they are welded to the profiled structures 21 in order to retain the platforms 7a; 7b at their position between the profiled structures 21.

The platforms 7a; 7b are oriented parallel to each other and positioned spaced above each other, so that the first platform 7a is configured as a lower platform and the second platform 7b is configured as an upper platform. The receptacle 3 is arranged on the lower platform 7a and the pump 4 is arranged on the upper platform 7b. Both platforms 7a; 7b comprise an adequately large distance to one another for enabling the receptacle 3 to be placed on the platform 7a or to be removed from the platform 7a for refilling or for replacement with an interchangeable receptacle.

Four of the six profiled structures 21a are configured and/or arranged, as already described, for retaining the platforms 7a; 7b parallel to each other above each other and at an adequately large distance to each other. For this purpose, the four profiled structures 21a are configured as vertical supports arranged particularly perpendicularly to the platforms 7a; 7b and to the frame profiles 71a; 71b. The remaining two of the six profiled structures 21b start from the upper platform 7b and from the upper frame profile 71b and extend further upwards.

Each of the two profiled structures 21b comprises a first and a second fractional section 211a; 211b, the first fractional sections 211a of both profiled structures 21b being arranged at an angle Alpha of approximately 75 degrees to the upper platform 7b and to the upper frame profile 71b. The second fractional sections 211b of both profiled structures 21b are arranged at an angle Beta of approximately 135 degrees to the first fractional section 211a and prolongs this upwards up to a crossing or connecting point K in which the two profiled structures 21b converge.

The lubrication station 1 comprises a center of gravity S that is situated on a plane (not shown) parallel to the platforms 7a; 7b. The crossing and connecting point K is arranged on a straight line G which—even in the standing position of the lubrication station on the base—intersects the plane perpendicularly in the center of gravity.

The mechanical interface 5 is arranged in the crossing or connecting point K. The mechanical interface 5 is configured and/or arranged for lifting or lowering and/or for carrying the lubrication station 1 in a ready-to-operate orientation. Due to fact that the mechanical interface 5 is arranged on the straight line G which extends through the center of gravity S, the lubrication station 1 can be lifted and set down again, safe against tilting, in an operable state. For this purpose, the interface can be coupled to the external and externally driven lifting device, particularly a crane, which is configured for moving the lubrication station 1 in a vertical direction, particularly upwards. In this way, the lubrication station 1 can be lifted from a bottom of the wind power plant tower to the wind power plant car situated at a distance from the bottom.

Through the lifting device coupled to the mechanical interface 5, the lubrication station 1 can also be moved in horizontal direction in that after reaching an upper end of the wind power plant tower, the lubrication station 1 is shifted to the base U of the wind power plant car.

The castors 6 are arranged on an underside of the lower platform 7a or an underside of the lower frame profile 71a oriented toward the base U. The castors 6 are configured for shifting and/or moving the lubrication station 1 on the base U. The castors 6 enable the user to shift, roll or push the lubrication station 1 to the point of delivery of the lubricant in the wind power plant car.

The receptacle 3 is configured for receiving more than 3 kg, preferably more that 6 kg and particularly more than 10 kg of the lubricant as a lubricant stock. By reason of the large lubricant stock of the receptacle 3 compared to conventional lubrication devices, the user can be spared a regular, time-consuming refilling of the lubricant stock. If necessary, the receptacle 3 can be refilled or exchanged.

The pump 4 is configured for pumping lubricant out of the receptacle 3. The counter unit 41 is configured for detecting the pumped quantity of the lubricant. The evaluating unit evaluates the detected pumped quantity, following which, the control unit activates the indicator unit, configured as a display, thus enabling a graphical display of the pumped quantity. In this way, the counter and indicator unit 41 enables the user to pump an exactly defined quantity of lubricant into the point of delivery.

The hand-held dosing device 42 is configured for a manual dosing of the lubricant. For facilitating handling, the hand-held dosing device 42 can be taken off the receiving device 2. The hand-held dosing device 42 comprises an actuating lever that is configured for being operated by the user.

### LIST OF REFERENCES

1 Lubrication Station
2 Receiving Device
21 Profiled Structures
211 Fractional Sections of the Profiled Structures
3 Receptacle
4 Pump
41 Counter and Indicator Unit
42 Hand-Held Dosing Unit
5 Mechanical Interface
6 Castors
7 Platforms
71 Frame Profiles
G Straight Line
K Crossing and/or Connecting Point
o Up
U Base
S Center of Gravity

1-15. (canceled)

16. A lubrication station for lubricating a bearing with a lubricant, the lubrication station, comprising:
a pump for pumping the lubricant;
a receptacle for receiving the lubricant as a lubricant stock for the pump;
a receiving device for receiving the pump and the receptacle in a transportable and operable state; and
a mechanical interface for lifting or lowering and/or carrying the lubrication station,
wherein the lubrication station is a mobile standing device.

17. The lubrication station according to claim 16, wherein the receiving device has at least one platform and at least one profiled structure, the platform is fixed on the at least one profiled structure and receives the pump and/or the receptacle.

18. The lubrication station according to claim 16, wherein the receiving device has a height of at least 50 cm

19. The lubrication station according to claim 16, wherein the receiving device has a height of at least 90 cm.

20. The lubrication station according to claim 16, wherein the receiving device has a height of at least 135 cm.

21. The lubrication station according to claim 17, wherein the platform or a plane extending parallel to the platform has a center of gravity, and the mechanical interface is arranged and/or fixed on the receiving device while being situated on an imaginary straight line that intersects the plane perpendicularly in the center of gravity.

22. The lubrication station according to claim 16, wherein the mechanical interface is configured and/or arranged to lift or to lower and/or to carry the lubrication station in a ready-to-operate orientation.

23. The lubrication station according to claim 16, wherein the mechanical interface is coupleable to a lifting device for vertical lifting.

24. The lubrication station according to claim 16, further comprising a plurality of castors for shifting and/or moving the lubrication station on a base.

25. The lubrication station according to claim 16, wherein the receptacle is can receive more than 3 kg of the lubricant as a lubricant stock.

26. The lubrication station according to claim 16, wherein the receptacle is can receive more than 6 kg of the lubricant as a lubricant stock.

27. The lubrication station according to claim 16, wherein the receptacle is can receive more than 10 kg of the lubricant as a lubricant stock.

28. The lubrication station according to claim 16, wherein the pump is an electrically operating pump.

29. The lubrication station according to claim 16, wherein the pump is configured for energy-independent operation.

30. The lubrication station according to claim 16, further comprising a counter and/or an indicator device which detects and/or indicates a pumped quantity of the lubricant.

31. The lubrication station according to claim 16, further comprising a hand-held dosing unit for a manual dosing of the lubricant, the hand-held dosing unit having an outlet for letting out the lubricant, and the outlet being connectable to an external feeding device.

32. A method of lubricating a bearing of a wind power plant with a lubrication station, which is a mobile standing device, having a pump, a receptacle, a receiving device and a mechanical interface, the method comprising the following steps:
pumping lubricant using the pump;
receiving the lubricant as a lubricant stock for the pump by means of the receptacle;
receiving the pump and the receptacle in a transportable and operable state by means of the receiving device; and
lifting or lowering and/or carrying the lubrication station by means of the mechanical interface.

33. The method according to claim 32, further comprising the step of lifting the lubrication station at the mechanical interface through a lifting device to a place of use in the wind power plant.

34. The lubrication station according to claim 16, wherein the lubrication station lubricates a bearing of a wind power plant according to a method comprising the following steps pumping lubricant using the pump; receiving the lubricant as a lubricant stock for the pump by means of the receptacle; receiving the pump and the receptacle in a transportable and operable state by means of the receiving device; and lifting or lowering and/or carrying the lubrication station by means of the mechanical interface.
